(19) United States
(12) Patent Application Publication
(10) Pub. No.: US 2014/0374537 A1
(43) Pub. Date: Dec. 25, 2014

(54) Portable Airborne Multi-Mission Platform

(71) Applicant: Alexander Anatoliy Anderson, North Bend, WA (US)

(72) Inventor: Alexander Anatoliy Anderson, North Bend, WA (US)

(21) Appl. No.: 13/952,585

(22) Filed: Jul. 27, 2013

Related U.S. Application Data
(63) Continuation-in-part of application No. 13/926,073, filed on Jun. 25, 2013.

(51) Int. Cl. B64B 1/50; B64D 45/02

(52) U.S. Cl. CPC B64B 1/50; B64D 45/02
USPC 244/1 A; 244/33

(57) ABSTRACT

A portable airborne multi-mission platform designed to collect meteorological data and perform other missions, either alone or in a modular array. Each portable airborne multi-mission platform comprises a tethered aerostat; a hydrogen generation, storage, and recovery system; and a control system. The tethered aerostat consists of an airship, a horizontal axis wind turbine, and a tether cable. The airship is both self-inflating and self-deflating and has the geometry of a wind concentrator and diffuser in fluid communication with the wind turbine.

### CROSS-REFERENCE TO RELATED APPLICATIONS

This application is a continuation-in-part of U.S. patent application Ser. No 13/926,073, filed Jun, 25, 2013.

### US PATENT DOCUMENTS

| | | |
|---|---|---|
| 2,151,336 | March 1939 | Scharlau |
| 4,120,259 | October 1978 | Wilson |
| 4,155,252 | May 1979 | Morrill |
| 4,325,122 | April 1982 | Parks, et al. |
| 4,842,219 | June 1989 | Jakubowski, et al. |
| 4,842,221 | June 1989 | Beach, et al. |
| 5,470,032 | November 1995 | Williams, Jr., et al. |
| 5,646,343 | July 1997 | Pritchard |
| 5,752,088 | May 1998 | Desselle |
| 6,425,678 | July 2002 | Verdes, et al. |
| 6,793,180 | September 2004 | Nachbar, et al. |
| 6,896,222 | May 2005 | Dossas, et al. |
| 7,133,001 | November 2006 | Mrstik, et al. |
| 7,251,502 | July 2007 | Page, et al. |
| 7,341,224 | March 2008 | Osann, Jr. |
| 7,589,641 | September 2009 | Wobben |
| 7,988,086 | August 2011 | Tichborne, et al. |
| 8,018,489 | September 2011 | McCutchen |
| 8,116,763 | February 2012 | Olsen |
| 8,186,614 | May 2012 | Sanchez-Brunete lvarez, et al. |
| 8,200,435 | June 2012 | Stiesdal |
| 8,253,265 | August 2012 | Glass |
| 8,365,471 | February 2013 | Diniz, et al. |
| 8,485,465 | July 2013 | Lee |
| 20080299990 | December 2008 | Knoblach; Gerald M.; et al. |
| 20110016804 | January 2011 | Howard; Lonnie; et al. |
| 20110192938 | August 2011 | DiMarzio; Donald; et al. |
| 20110267241 | Nov. 3, 2011 | Grimm; Thomas; et al. |

### FOREIGN PATENT DOCUMENTS

| | |
|---|---|
| EP 0771729 | May 1997 |
| WO 2011095666 | Aug. 11, 2011 |
| EP 2525243 | November 2012 |

### OTHER REFERENCES

Advisory Circular AC 70/7460-1K “Obstruction Marking and Lighting,” US Department of Transportation/Federal Aviation Administration, February 2007

Safety Recommendation A-13-016-017, National Transportation Safety Board, May 2013

Safety Recommendation A-13-018-019, National Transportation Safety Board, May 2013

NTSB Safety Alert SA-016, “Meteorological Evaluation Towers,” National Transportation Safety Board, March 2011.

### FIELD OF THE INVENTION

The present invention relates to the use of a portable tethered aerostat to gather meteorological data, as well as perform other missions including reconnaissance, aerial surveillance or photography, and communications.

### BACKGROUND OF THE INVENTION

Currently, nearly all meteorological data is gathered using meteorological masts, that is a portable tower that carries meteorological instruments, typically including equipment to measure the ambient pressure, temperature, wind speed, wind direction, humidity, etc. Typically, such towers are constructed from a lattice structure or long metal pole that is stabilized by guy wires, and are implemented around rocket launch pads, nuclear power stations, and wind farms. Additionally, meteorological masts are used to determine the wind patterns around future wind farms, thereby allowing wind energy developers to accurately estimate the performance of the candidate wind site. In this application, meteorological towers are currently quite attractive due to the ease and speed with which they can be assembled, usually within a few hours.

However, there recently have been three fatal accidents in the United States during which aircraft collided with meteorological towers and subsequently crashed, killing all occupants. Indeed, meteorological masts pose a significant hazard to aircraft since MET towers can be erected very quickly, and typically, without any notice to the aviation community, creating a significant change to the navigable airspace. Moreover, because most MET masts are less than 200 feet tall, their operators are not usually required by 14 CFR Part 77 to notify the Federal Aviation Administration or to implement a lighting marking plan in accordance with Advisory Circular 70/7460-1K. As a result, pilots have no knowledge of the location of MET towers and have reported difficulty seeing erected MET towers. Finally, it is currently unknown how many MET towers are currently constructed in the United States.

Recently, the National Transportation Safety Board released six safety recommendation letters to agencies including the Federal Aviation Administration and the American Wind Energy Association requesting changes to documents including AC 70/7460-1 and the Wind Energy Siting Handbook requiring all MET towers to be registered, marked, and lighted. However, the FAA stated that it is not currently considering any further action and that it is impractical to require lighting of MET towers due to their remoteness from pre-existing power sources.

Therefore, meteorological masts continue to pose a threat to low-altitude aviation operations, including emergency medical services, law enforcement, fish and wildlife surveys, agricultural applications, and aerial fire suppression. Although there have been various innovations addressed toward the field of meteorological observation, such as U.S. Pat. Nos. 8,365,471; 5,646,343; or 8,257,040, hardly any address the hazards that meteorological measurement systems pose to aircraft. Consequently, there exists a need for an alternative method to gather meteorological data without posing a hazard to low-flying aircraft.

### SUMMARY OF THE INVENTION

The present invention directly addresses the aforementioned problems with prior art, while at the same time possessing greater portability and the ability to perform other missions, such as reconnaissance, surveillance, or communications.

The present invention comprises a tethered aerostat that houses a horizontal axis wind turbine, a control system that regulates the internal pressure and altitude of the tethered airship, and a hydrogen generation, recovery, and storage system. The tethered aerostat is filled with hydrogen gas so that it is buoyant in the atmosphere and also features the geometry of a high-efficiency concentrator-diffuser wind turbine augmenter, namely a volume of revolution with an airfoil cross-section. The tethered aerostat additionally carries a payload, in the primary instance, a set of meteorological instruments to measure the ambient temperature, barometric pressure, relative humidity, etc. However, the meteorological payload can be substituted with any other payload, such as aerial surveillance or radio telecommunications equipment.

The present invention is self-powered through the use of the horizontal axis wind turbine, which is mounted in the narrowest cross-section of the airship and is connected to a gearbox that turns an electric generator. The electrical energy generated by the wind turbine is used to power a electrolysis system to generate hydrogen gas, which is used to inflate the tethered airship and stored for future use. During periods of low winds when the wind turbine does not provide sufficient energy to power the control system and payloads, the present invention uses a fuel cell to recombine the stored hydrogen with oxygen to provide the required amount of electrical power.

The present invention is highly portable since the system additionally recovers the hydrogen used to inflate the airship by activating the hydrogen recovery system, thereby allowing the present invention to be deflated and redeployed without the need for additional lighter-than-air gas to re-inflate the airship, while simultaneously allowing the present invention to continue to power the payload, even during deflation. The present invention also includes a system to prevent damage to the assembly from static discharge and lightning strikes through the use of metallic film coatings, static discharge ports, and grounding wires.

Finally, the present invention can also be deployed in a modular 2-dimentional or 3-dimentional array, thereby presenting additional advantages, such as the compilation of a 3-dimenionsional map of meteorological conditions in the region of interest or the operation of multiple surveillance or communications systems simultaneously.

### BRIEF SUMMARY OF THE DRAWINGS

FIG. 1 depicts the tethered aerostat, inflated and tethered to its ground station.

FIG. 2 depicts the tethered aerostat and its components

FIG. 3 depicts the front view of the tethered aerostat

FIG. 4 depicts a half-section view of the airship taken along a vertical plane passing down the axis of symmetry.

FIG. 5 depicts a half-section view of the airship taken along a horizontal plane passing along the axis of symmetry.

FIG. 6 depicts the planes along which the sectional view in FIG. 7 was taken.

FIG. 7 depicts a ¾ sectional view depicting the internal geometry and components of the airship.

FIG. 8 depicts the hydrogen generation, storage, and recovery system.

FIG. 9 depicts the four Y-valves that allow the hydrogen system to switch modes of operation.

FIG. 10 depicts a winch used to control the length of the tether for the airship.

FIG. 11 depicts the present invention deployed in a two-dimensional array.

### DETAILED DESCRIPTION

The following description details an exemplary configuration of the present invention that may be embodied in many different geometries, forms, and configurations. Therefore, specific structural and functional details disclosed herein are not to be interpreted as limiting, but merely as a representative basis for the set of possible configurations of the present invention.

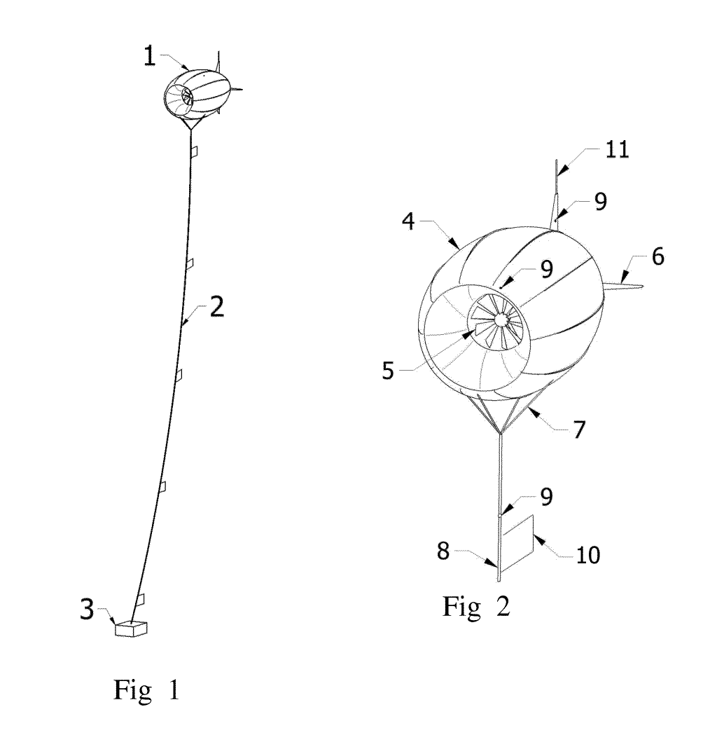

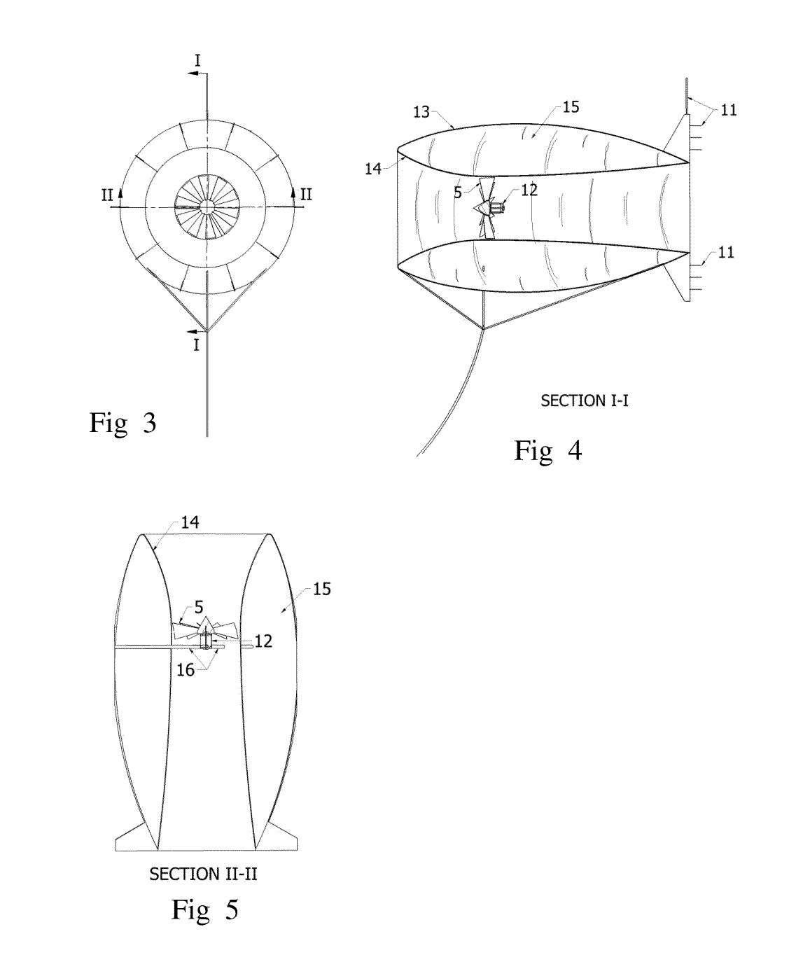

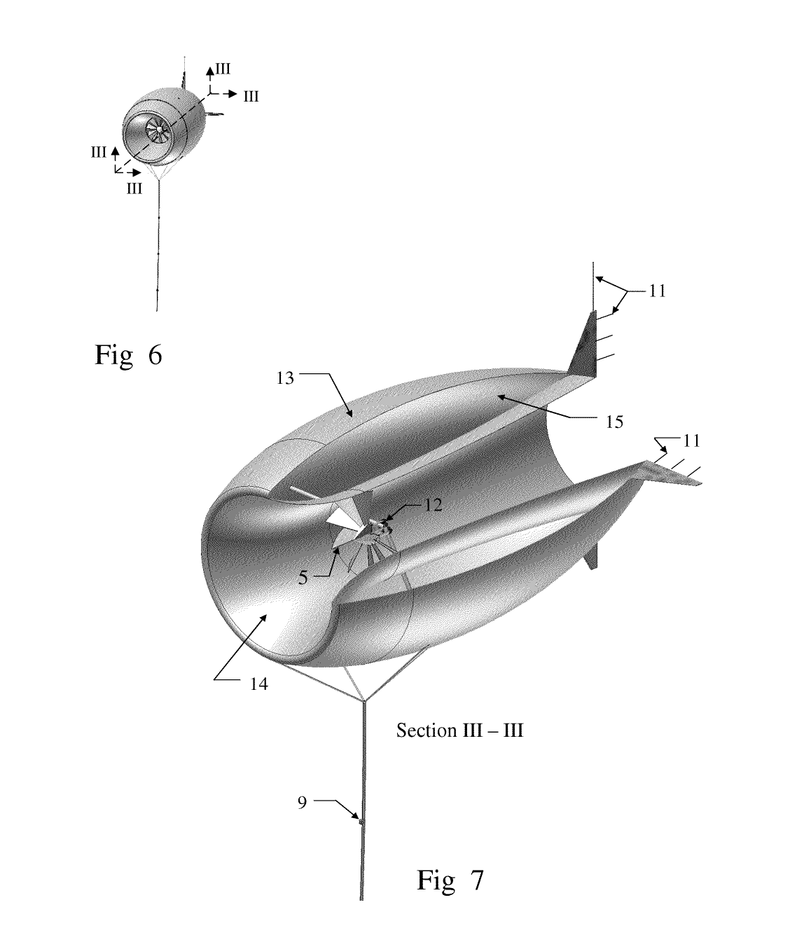

As depicted in FIG. 1, the present invention comprises a tethered aerostat 1, that is tethered to the ground via a long tether 2, that is terminated inside the ground station 3. As depicted in FIG. 2, the tethered aerostat comprises a thin-walled envelope 4, in whose center is mounted a horizontal axis wind turbine 5. The airship is filled with hydrogen gas so that it is buoyant and supports the weight of the desired payload (not depicted). The geometry of airship is that of a volume of revolution with an airfoil cross-section, causing the airship to function as a wind concentrator-diffuser augmenter. The design consists of a venturi nozzle in fluid communication with a diffuser, such that the wind passing by the aerostat is accelerated through the hole in the airship and over the blades of the wind turbine. Preferably, the airship features an optimized geometry to maximize the airflow through the center of the blimp; such a geometry can be determined by either empirical or numerical analysis techniques. The airship is preferably tethered with at least three tethers 7 that are joined into a single central tether 8 to help equally distribute the aerodynamic loads between the airship and the central tether. The airship is directed into the oncoming wind direction by the combination of a larger surface area of diffuser portion of the airship and the stabilizing fins 6.

The airship envelope 4 is preferably made of a resilient flexible material or set of materials so as to minimize effusion of the hydrogen gas from the assembly. The assembly could use a thin polymer film (such as polyethylene, Mylar®, or any other similar material) to maintain the pressure of the assembly while using a high-strength woven fiber (Dacron®, Vectran®, Spectra®, Kevlar®, carbon fiber, or any other material suitable for the application) to maintain the shape of the shroud. Additionally, the inflated components could be coated with a UV resistant and/or abrasion resistant coating, such as Tedlar® to ensure the desired level of strength to maximize the lifetime of the present invention.

The airship may also include a lightweight, collapsible internal structure, such as ribs, stringers, or other similar frame to help the airship maintain its geometry during turbulent winds. The internal structure would be preferably manufactured from a lightweight composite material, such as a plastic reinforced with carbon fiber, fiberglass, Kevlar®, Spectra®, or any other suitable material. However, it is important to recognize that the structural details described above are not limiting, but a guideline for those skilled in the art to understanding the nature of the present invention.

Additionally, to minimize the risk of accidents caused by static electricity or lightning strikes, the internal and external surfaces of the shroud are coated with a thin metallic film, such as that commonly used in the electronics industry to protect integrated circuits from static discharge. The metallic films could also be supplemented by a conductive metallic mesh or foil, such as is used in the aircraft industry to protect composite aircraft from lightning strikes. The metallic films and/or meshes would then be connected to a ground wire and static discharge ports 11. The static discharge ports 11 would also serve to protect the system from lightning strikes by providing a discharge path around the important components of the system.

Finally, the airship and its tethers incorporate obstruction marking and lighting in accordance with Chapter 11 of Advisory Circular AC 70/7460-1K to help minimize the hazards posed to aircraft. As depicted in FIGS. 2 and 7, flashing red or white obstruction lights 9 are placed on the leading and trailing edges of the airship, as well as along the length of the tether, spaced in equal intervals. Additionally, the airship tether includes stiffened flags 10 spaced along the length of the tether to increase the visibility of the airship during the daytime.

As depicted in FIG. 4, the airship envelope includes an outer surface 13 and an inner surface 14. The volume 15 bounded between the two envelopes is filled with hydrogen gas that is generated in the ground station and delivered to the airship via the tether. The horizontal axis wind turbine 5 is mounted in the narrowest section of the inner surface of the envelope 14, thereby increasing the speed of the wind passing over the blades of the wind turbine, and thus maximizing the efficiency of the wind turbine. The wind turbine 5 is connected to a gearbox and electrical generator 12, thereby converting the available mechanical energy of the wind into electrical energy to power the airship and its payload. The electrical generator 12 may be synchronous or asynchronous AC 1-phase or 3-phase, DC, or any suitable electrical generator, as desired by the designer. However, a DC generator is preferred since most electronics, especially hydrogen electrolysis units, operate off of direct current; using a direct current electric generator would thereby eliminate the need for an inverter, hence reducing the size, weight, and cost of the present invention.

FIG. 5 depicts the one of the possible support structures that could be used to constrain the wind turbine and the electric generator within the airship. One possible support structure is the use of three lightweight ropes 16, manufactured of a lightweight fiber or other suitable material. When the assembly is fully inflated, the inners surface 14 of the airship envelop would pull the ropes 16 taut, thereby suspending the turbine in the throat of the airship. However, there are many other possible support structures not depicted, such as the use of a housing and supporting rods that are fastened to the internal stiffening structure or any other suitable method of constraining the wind turbine within the center of the airship. In no way are the designs discussed here intended to be limiting of the shape, reinforcements, or any other aspect of the design of the inflatable aerostat, but to give the designer an understanding of the present invention.

FIG. 7 depicts a three-quarter section view of the tethered aerostat, depicting the aforementioned components of the airship, including the inner and outer surfaces of the airship envelope 13 and 14, the wind turbine 5 and electric generator 12, the static discharge ports 11, and one of the obstruction lights 9 spaced along the tether.

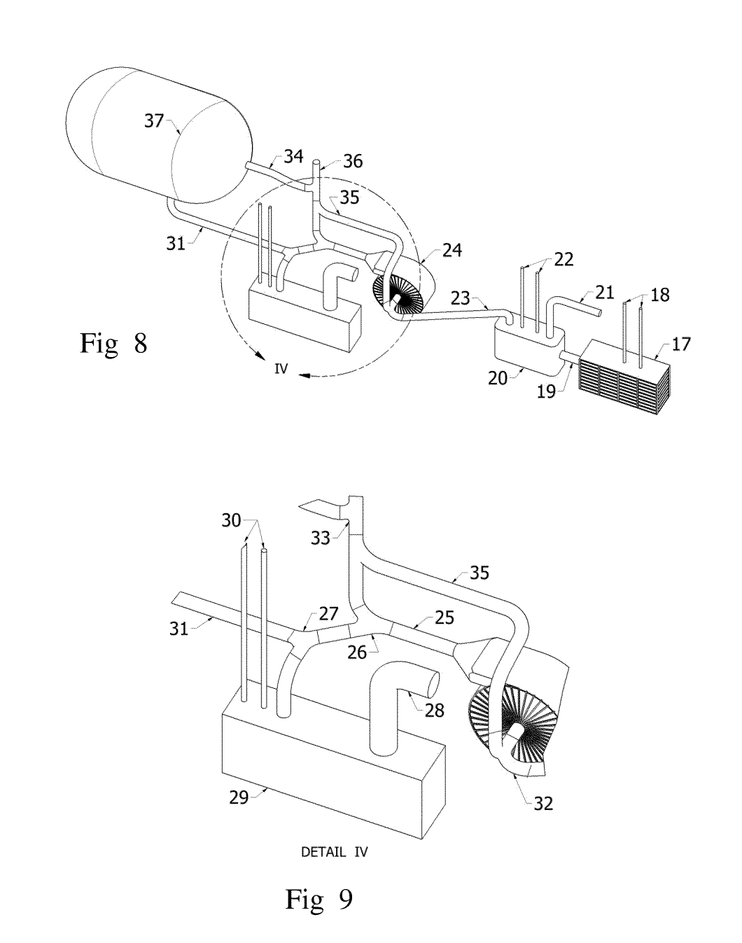

FIG. 8 depicts the hydrogen generation, recovery, and storage system, which is used to inflate the tethered aerostat and store energy for future use by the payloads. The system comprises a condenser 17, a hydrogen electrolysis unit 20, a compressor 24, a fuel cell 29, a hydrogen gas storage tank 37, and Y-valves 26, 27, 32, and 33.

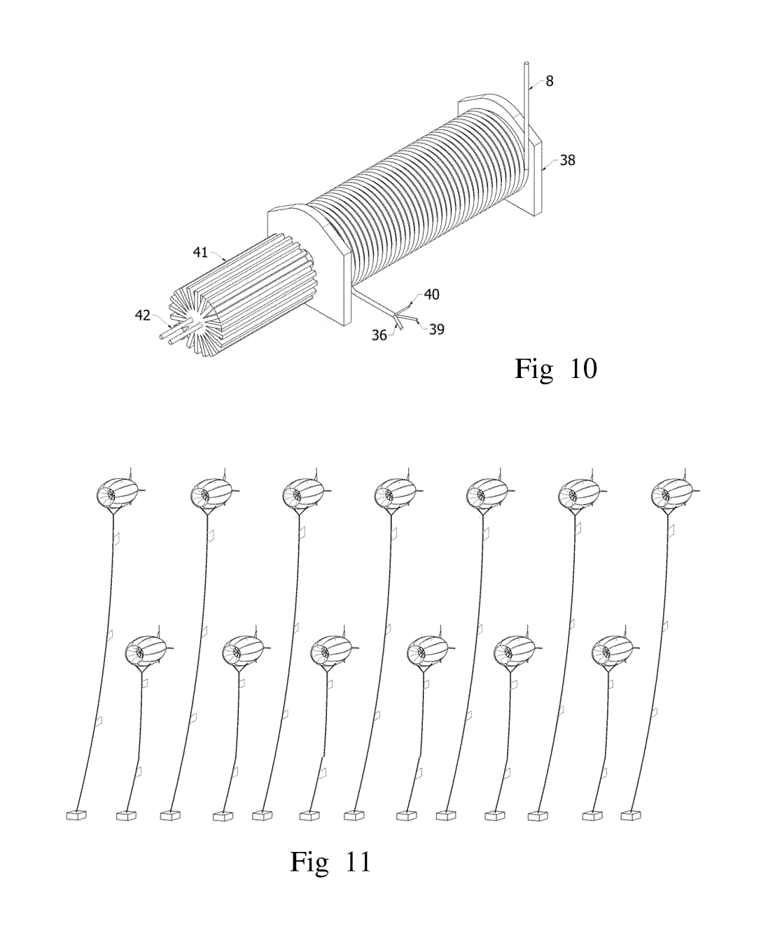

The present invention stores the electrical energy generated by the wind turbine by converting it to hydrogen as described herein. The wind turbine supplies electrical power to the condenser 17, which condenses the water vapor from the surrounding atmosphere, through the electrical leads 18. The condenser then pumps the condensed water into the electrolysis unit 20 through a water line 19. The electrolysis unit also receives electrical power from the wind turbine through wires 22 that are connected to the electrodes inside the unit, which decompose the water generated by the condenser in hydrogen and oxygen. The oxygen gas is exhausted from the unit through line 21, where it is either vented into the atmosphere or supplied to some other system, such as breathing oxygen, compression and storage in a tank, or any other system desired by the designer or consumer. The hydrogen then passes through line 23, where it is compressed by the compressor 24 to a higher pressure. As depicted in FIGS. 9 and 10, the hydrogen gas exits through line 25, after which it is directed by Y-valves 25 and 27 into line 31, which fills the hydrogen storage tank 37.

The hydrogen generation, storage, and recovery system is also operated by a feedback control system to regulate the pressure of the hydrogen gas contained within the airship envelope. The feedback system would monitor the pressure of the hydrogen gas using a pressure transducer or other appropriate device that would supply data concerning the gas pressure to the control system. When the internal pressure would fall below some predetermined minimum level, the control system would activate the condenser, electrolysis unit, and the compressor, which would operate as described before. However, Y-valves 26, 32, and 33 direct the compressed hydrogen gas into line 36, which is later integrated into the tether, which delivers the compressed hydrogen gas to the airship, re-inflating it to the required pressure. Conversely, if the internal pressure were to rise above a maximum value, the control system would, rather than venting the gas into the atmosphere, would switch Y-valves 32 so that the compressor would draw in hydrogen from line 35, thereby deflating the airship, and then pump the hydrogen gas into the storage tank for future use.

The hydrogen system can also power the control system and payloads during periods of low winds when the wind turbine is unable to produce sufficient power for the system. During such times, Y-valve 27 would switch so that the hydrogen storage tank 37 would supply hydrogen gas to the fuel cell 29, which would generate sufficient electricity to power the payloads.

Additionally, the hydrogen storage tank could be used to re-inflate the wind turbine by switching Y-valve 33 to allow hydrogen gas to exit the storage tank through line 34, after which it would pass into line 36, and then into the airship.

Furthermore, the hydrogen system allows the airship to be deflated without loss of the hydrogen gas that was used to inflate the airship by switching Y-valve 32, thereby allowing the compressor to pump all the hydrogen gas out of the airship and into the storage tank. The airship could then be easily folded and packed for transportation to another site. The aerostat, after arriving at its new destination could then be re-inflated with the hydrogen stored in the hydrogen storage tank.

As depicted in FIG. 10, the length of the tether is regulated by a winch or drum-type mechanism located in the ground station that comprises the drum and its supporting frame 38, a motor to turn the drum 41, which is powered by the control system through electrical leads 42. The tether 8 is wrapped around the drum, so that the aerostat can raised and lowered by extending or retracting the tether line. Finally, the tether line 8 consists of at least 3 internal lines, namely the hydrogen supply line 36, the electrical leads from the wind turbine 39, and the data cables for the control system and payload 40.

The entire assembly is controlled using a control system (not depicted) that controls the pressure of the hydrogen gas inside the blimp and the altitude of the blimp, as described herein. The control system includes, but is not limited to, the aforementioned feedback system to control the pressure of the hydrogen gas, a feedback control system to control the rotational speed of the wind turbine rotor, and a feedfoward control system that would protect the blimp from severe weather. The second feedback control system would control the altitude of the wind turbine and ensure that the wind turbine rotor does not reach excessive rotational speeds that could damage the assembly. The control system would feature a device to measure the altitude of the airship, preferably a GPS receiver, and another device to measure the angular velocity of the turbine blades and relay that information to the control system. Initially the control system would let the blimp rise until it reached the desired altitude, and then lock the mechanism controlling the length of the tethers. However, if the wind turbine rotor was to reach a predetermined maximum angular speed, the control system would decrease the length of the tether until the blimp reached an altitude with a sufficiently low wind speed, thus protecting the wind turbine and airship from structural damage.

Lastly, the third control system features a feedfoward system that would be activated by the operator to retract the airship to ground level in case of severe weather aloft, thus protecting the system from damage that it could have encountered at high altitudes. However, if severe weather is expected at both altitude and ground level, the user-activated feedfoward control system would also deflate the airship using the hydrogen recovery system that was described earlier, thus minimizing any possible damage to the portable airborne multi-mission platform.

The present invention can be used for a variety of applications, including meteorology, reconnaissance, surveillance, or radio telecommunications. In the primary instance, the meteorological data collection payload would typically include instruments for measuring the temperature, pressure, humidity, etc. However, due to the innovative design of the tethered aerostat, the use of a conventional wind meter to determine the wind speed and direction is not necessary. The present invention would determine the wind speed of the air passing by the tethered aerostat by measuring the power output and/or the rotational speed of the horizontal axis wind turbine, and then using an algorithm to determine the wind speed via a calibration curve developed for the aerostat system. Likewise, since the airship self-orients into the oncoming wind direction and will always be slightly downwind of the ground station, the system would determine the wind direction by comparing the location of the airship, as preferably determined by a GPS receiver, with the coordinates of the ground station. In other embodiments, the present invention would serve as a portable, versatile platform for other payloads including high resolution cameras, radio transmitters and receivers, or any other desired payload.

Finally, as depicted in FIG. 11, the tethered airships may be arranged in a two-dimensional or three-dimensional array. In the primary application of gathering meteorological data, deployment of the present invention in an array allows the operator to gather information and generate a two-dimensional or even three-dimensional grid of meteorological data, which can serve to help predict the future meteorological conditions for the region of interest with far greater accuracy than a single deployment of the present invention. For other applications, a plurality of airships can serve to provide surveillance of multiple regions simultaneously, allow improved performance of a radio communications by creating an array of radio transmitters, etc.

The invention claimed is:

1. A portable airborne multi-mission platform designed to collect meteorological data and perform other missions, wherein the portable airborne multi-mission platforms may be arranged in a modular array, wherein each portable airborne multi-mission platform comprises a tethered aerostat; a hydrogen generation, storage, and recovery system; and a control system, wherein the tethered aerostat consists of an airship, a horizontal axis wind turbine contained in the airship, and a tether cable, wherein the tethered aerostat is both self-inflating and self-deflating, wherein the tethered aerostat has the geometry of a wind concentrator and diffuser in fluid communication with the horizontal axis wind turbine.

2. The portable airborne multi-mission platform of claim 1, wherein the airship is a volume of revolution with an airfoil cross-section designed to accelerate the airflow through the center of the said airship in order to maximize the efficiency of the horizontal axis wind turbine, wherein the airship is directed into the oncoming wind by a set of stabilizing fins located at the exit of the diffuser section of the airship.

3. The portable airborne multi-mission platform of claim 2, wherein the horizontal axis wind turbine is located in the narrowest section of airship between the concentrator and diffuser sections of the airship, wherein the horizontal axis wind turbine turns an electric generator that powers the payloads; the hydrogen generation, storage, and recovery system; and the control system.

4. The portable airborne multi-mission platform of claim 3, wherein the airship is inflated using a lighter-than-air gas, whereby the airship is buoyant and supports the weight of the horizontal axis wind turbine and the payloads carried by the airship, wherein the said lighter-than-air gas is hydrogen.

5. The portable airborne multi-mission platform of claim 4, wherein the airship tether includes at least a hydrogen gas supply line, a electrical power cable, and a data cable, wherein the electrical power cable contains at least a hot wire, a neutral wire, and a ground wire.

6. The portable airborne multi-mission platform of claim 5, wherein the ground wire is connected to static discharge ports located on the trailing edge of the airship and at least one other anti-static discharge safety feature including metallic films, foils, or meshes applied to the internal structure and envelope of the airship.

7. The portable airborne multi-mission platform of claim 6, wherein the hydrogen gas used to inflate the airship is generated by the hydrogen generation, storage, and recovery system comprising a condenser, an electrolysis unit, a compressor, a storage tank, and a fuel cell.

8. The portable airborne multi-mission platform of claim 7, wherein the hydrogen generation, recovery system is controlled by a control system, wherein the control system includes at least two feedback control systems and a user-activated feedfoward control system.

9. The portable airborne multi-mission platform of claim 8, wherein the first feedback control system regulates the internal pressure of the airship, whereby if the internal pressure of the system drops to a predetermined minimum pressure, the said feedback control system pumps more hydrogen into airship, whereby if the internal pressure in the airship were to exceed a predetermined maximum pressure, the said feedback system would pump hydrogen out of the airship.

10. The portable airborne multi-mission platform of claim 9, wherein the second feedback control system monitors the angular velocity of the wind turbine and decreases the length of airship's tether if the wind turbine rotor reaches a predetermined maximum rotational speed, thereby reducing the altitude of the airship, and hence, the wind speed passing through the wind turbine rotor.

11. The portable airborne multi-mission platform of claim 10, wherein the user-activated feedfoward control system would retract the airship to ground level if severe weather were predicted at high altitude, wherein the user-activated feedfoward control system would additionally fully deflate the airship using the hydrogen generation, storage, and recovery system if severe weather were expected both at altitude and at ground level.

12. The portable airborne multi-mission platform of claim 11, wherein the tethered airship carries meteorological equipment to measure at least the ambient air temperature, pressure, and humidity.

13. The portable airborne multi-mission platform of claim 12, wherein the wind speed is determined from the power output and/or rotational speed of the horizontal axis wind turbine.

14. The portable airborne multi-mission platform of claim 13, wherein the wind direction is determined from the position of the airship relative to the ground station, wherein the position of the airship is measured by a navigational instrument, such as GPS receiver.

15. The portable airborne multi-mission platform of claim 11, wherein the meteorological payload may be substituted for other equipment, wherein other payloads can include but are not limited to equipment for use in reconnaissance, aerial surveillance or photography, or radio telecommunications.
